(19) United States
(12) Patent Application Publication
(10) Pub. No.: US 2026/0325995 A1
(43) Pub. Date: Oct. 22, 2026

(54) ON-LINE MAINTAINABLE FILTER AND OPERATING METHOD THEREOF

(71) Applicant: Caterpillar Inc., Peoria, IL (US)

(72) Inventors: Baocheng ZHANG, Wuxi (CN); Longtan XU, Wuxi (CN); Guoping TIAN, Wuxi (CN); Lei YU, Wuxi (CN)

(21) Appl. No.: 19/468,296

(22) Filed: Feb. 3, 2026

(30) Foreign Application Priority Data
Feb. 5, 2025 (CN) 202510130541.4

(51) Int. Cl. B01D 29/66; B01D 29/01; B01D 35/30

(52) U.S. Cl. CPC B01D 29/66; B01D 29/014; B01D 35/30

(57) ABSTRACT

The present disclosure relates to a filter and a method for operating the same. The filter comprises: a housing, a core, and a filtering device disposed on the core and being rotatable with the core between a filtering position and a cleaning position. The housing defines a filter chamber and is provided with a liquid inlet, a liquid outlet, a cleaning inlet and a cleaning outlet respectively communicating with the filter chamber. The core is arranged within the filter chamber. In the filtering position, the filtering device communicates with the liquid inlet and the liquid outlet so as to allow a fluid to be filtered to flow in a filtering direction; in the cleaning position, communication between the liquid inlet and the liquid outlet is cut off by the core, while the filtering device forms communication with the cleaning inlet and the cleaning outlet to allow a cleaning fluid to flow in a cleaning direction. With the filtering device as a reference, the filtering direction is opposite to the cleaning direction. The cleaning of the filter in the present disclosure no longer requires draining the filtered fluid or disassembling the filter, and online cleaning can be directly performed by adjusting the position of the core, making the entire cleaning and maintenance process simple and efficient.

### CROSS-REFERENCE TO RELATED APPLICATION

This application claims priority to Chinese Patent Application No. 202510130541.4, filed Feb. 5, 2025, which is hereby incorporated by reference in its entirety.

### TECHNICAL FIELD

The present disclosure relates to the technical field of work machine components, more particularly, to a filter that can be especially used in cooling systems of electric vehicles, such as electric work machines, and allows for on-line cleaning and maintenance. The present disclosure also relates to a method for operating said filter.

### BACKGROUND

As drive devices for new energy vehicles, such as electric work machines, electric motors can achieve low or zero emission. For electric vehicles, such as electric work machines, during the electric drive and energy recovery phase, electric motors will undergo losses which are dissipated outward in the form of heat. The heat must be carried away by a cooling medium of a cooling system. However, it is inevitable that the cooling medium is mixed with granular impurities during the flow process, such as impurities arising from friction and collision between two metal components. Consequently, a filter is usually installed in a flow path of the cooling medium for filtration.

In existing electric work machines, when the filter has captured excessive particulate impurities and thus must be serviced, the electric vehicle must be shut down to drain the cooling medium from the cooling system, then the filter must be disassembled for maintenance, e.g. removal of the attached particulates. The entire maintenance process is complicated and time-consuming.

### SUMMARY

It is an object of the present disclosure to solve at least one of the above problems and/or other problems existing in the prior art.

To achieve the above object, in one aspect, the present disclosure provides a filter. The filter comprises a housing, a core, and a filtering device disposed on the core and capable of rotating with the core between a filtering position and a cleaning position. The housing defines a filter chamber, and has a liquid inlet, a liquid outlet, a cleaning inlet and a cleaning outlet respectively communicating with the filter chamber. The core is rotatably disposed in the filter chamber. In the filtering position, the filtering device communicates with the liquid inlet and the liquid outlet to allow a fluid to be filtered to flow from the liquid inlet through the filtering device to the liquid outlet in a filtering direction. In the cleaning position, communication between the liquid inlet and the liquid outlet is cut off by the core, while the cleaning inlet and the cleaning outlet are communicated via the filtering device so as to allow a cleaning fluid to flow from the cleaning inlet through the filtering device to the cleaning outlet in a cleaning direction. With the filtering device as a reference, the filtering direction is opposite to the cleaning direction.

According to an embodiment of the present disclosure, a core body of the core defines an inner chamber and has a first filtering port and a second filtering port respectively communicating with the inner chamber, and the filtering device comprises a first filtering screen disposed in the first filtering port and a second filtering screen disposed in the second filtering port.

According to an embodiment of the present disclosure, the core body is generally spherical, the first filtering port and the second filtering port are opposite along a diameter of the core body, and can face the liquid inlet and the liquid outlet respectively when the core is in the filtering position.

According to an embodiment of the present disclosure, the first filtering port is formed in a beveled portion of the core body, and the first filtering screen is planar and obliquely disposed within the first filtering port.

According to an embodiment of the present disclosure, the second filtering screen is in the shape of a cone or an arc recessed into the inner chamber.

According to an embodiment of the present disclosure, a bottom of the core body is provided with a core body through-hole for filtered impurities to fall through.

According to an embodiment of the present disclosure, the housing comprises a cylindrical housing body with openings on both ends, a top cover and a bottom cover mounted on the openings, wherein the liquid inlet, the cleaning inlet and the liquid outlet are sequentially arranged in a circumferential wall of the housing body, and the cleaning outlet is arranged on the bottom cover.

According to an embodiment of the present disclosure, the filter further comprises a first screw plug and a second screw plug respectively disposed on the cleaning inlet and the cleaning outlet, wherein the second screw plug is a magnetic screw plug.

According to an embodiment of the present disclosure, the core comprises a core shaft extending from the top of the core body and a protrusion extending from the bottom of the core body, wherein the core shaft extends out through the top cover, and the protrusion is inserted into a bracket disposed at the bottom of the housing body.

In another aspect, the present disclosure provides a method for operating a filter. The filter comprises a housing, a core, and a filtering device disposed on the core and rotatable with the core, wherein the housing defines a filter chamber and has a liquid inlet, a liquid outlet, a cleaning inlet and a cleaning outlet respectively communicating with the filter chamber; the core is rotatably disposed within the filter chamber, and may be configured to allow the liquid inlet to communicate with the liquid outlet via the filtering device, so as to allow a fluid to be filtered to flow from the liquid inlet through the filtering device to the liquid outlet in a filtering direction. The method comprises the following steps:
when cleaning conditions are met, rotating the core to cut off communication between the liquid inlet and the liquid outlet, and enabling the cleaning inlet and the cleaning outlet to form communication through the filtering device, thereby allowing the cleaning fluid to flow from the cleaning inlet through the filtering device to the cleaning outlet in a cleaning direction, wherein with the filtering device as a reference, the filtering direction is opposite to the cleaning direction.

Advantageously, the cleaning conditions include that a pressure difference between the liquid inlet and the liquid outlet reaches a predetermined threshold.

The filter in the present disclosure includes a core rotatable within the filter chamber of the housing, by means of which the filtering device can be moved to the filtering position or the cleaning position. When the filtering device is in the filtering position, the fluid to be filtered can pass through the filtering device in a forward direction along the filtering direction to fulfill the filtering function; when the filtering device is in the cleaning position, the cleaning fluid can clean the filtering device in a reverse direction along the cleaning direction. In this way, when the filtering device needs to be cleaned, there is no longer a need to drain the fluid from the fluid system, e.g., the cooling system where the filter is located, and disassemble the filter for cleaning. Instead, online cleaning can be performed directly by adjusting the position of the filter core, making the entire cleaning and maintenance process simple and efficient.

### BRIEF DESCRIPTION OF THE DRAWINGS

The features and advantages of the present disclosure will be clearly understood through a detailed description provided below with reference to the accompanying drawings. It will be appreciated that the drawings are merely schematic and not necessarily drawn to scale, and thus shall not be construed as limiting the present invention.

FIG. 1 illustrates a perspective view of a filter according to an embodiment of the present disclosure;

FIG. 2 illustrates an exploded view of the filter illustrated in FIG. 1;

FIG. 3 illustrates an exploded view of a housing of the filter illustrated in FIG. 1;

FIG. 4 illustrates a cross-sectional view of the filter illustrated in FIG. 1, where the core is in a filtering position;

FIG. 5 illustrates a cross-sectional view of the filter illustrated in FIG. 1 from another angle, where the core is in a cleaning position.

### LIST OF REFERENCE SIGNS

1. Housing; 11. Housing body; 12. Top cover; 121. Through-hole; 13. Bottom cover; 14. Filter chamber; 15. Bracket; 16. Liquid inlet; 17. Liquid outlet; 18. Cleaning inlet; 19. Cleaning outlet; 2. Core; 21. Core body; 22. Core shaft; 23. Protrusion; 24. Inner chamber; 25. First filtering port; 26. Second filtering port; 27. Core body through-hole; 3. First filtering screen; 4. Second filtering screen; 5. First screw plug; 6. Second screw plug.

### DETAILED DESCRIPTION

Embodiments of the present disclosure will be described below with reference to the drawings. In the following description, numerous specific details are set forth in order to make those skilled in the art fully understand and implement the present disclosure. However, it will be apparent to those skilled in the art that the present disclosure may be implemented without some of these specific details. Furthermore, it will be appreciated that the present disclosure is not limited to the specific embodiments described herein. Rather, any combination of features and elements described below can be used to implement the present disclosure, regardless of whether they relate to different embodiments. Therefore, the following aspects, features, embodiments and advantages are for illustration only, and should not be regarded as elements or limitations of the claims, unless explicitly stated in the claims.

Terms such as “first” and “second” are used herein to describe the elements of the present disclosure, and they are only used to distinguish individual elements, rather than to limit the nature, order or number of the elements. The terms “comprising”, “including” and “having” are used to indicate an open-ended inclusion, and mean that there may be other elements/components besides the listed elements/components.

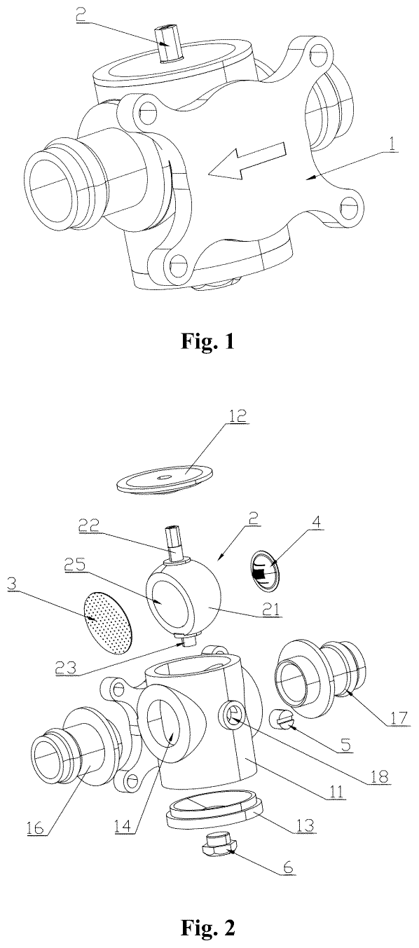

FIGS. 1 and 2 illustrate a filter according to an embodiment of the present disclosure. As shown in FIGS. 1 and 2, the filter according to this embodiment may include a housing 1, a core 2, and a filtering device.

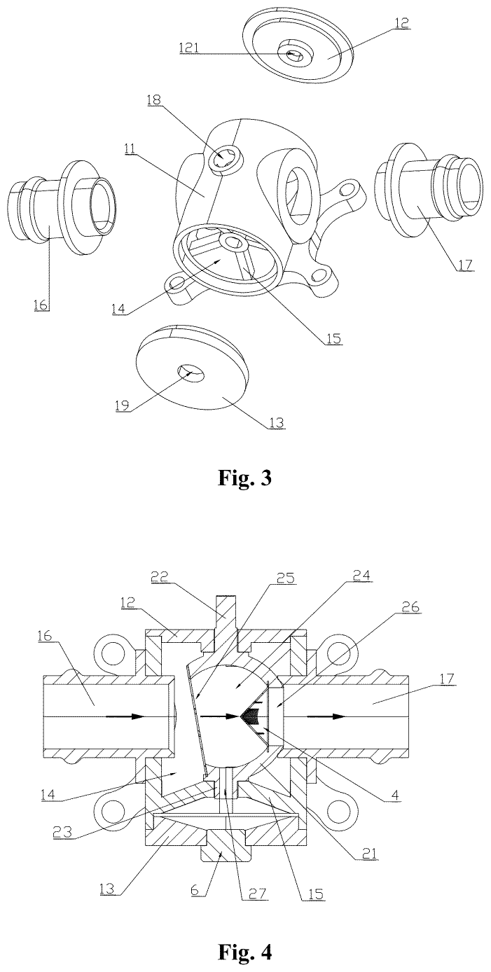

FIG. 3 shows a specific example of the housing 1 according to the present embodiment. As shown in FIGS. 2 and 3, the housing 1 includes a housing body 11, a top cover 12, and a bottom cover 13. The housing body 11 is generally cylindrical and has openings at its top and bottom ends. The top cover 12 and the bottom cover 13 are hermetically connected to the two openings of the housing body 11 to jointly delimit a filter chamber 14 with the housing body 11. A bracket 15 connected to a circumferential wall of the housing body 11 for supporting the core 2 may be provided near the bottom of the filter chamber 14. The bracket 15 includes a plurality of ribs arranged at equal intervals and extending radially along the housing body 11, and an annular portion connected to inner ends of the plurality of ribs. A channel for fluid circulation may be defined between two adjacent ribs, allowing both the fluid and impurities therein to flow toward the bottom cover 13.

Still referring to FIGS. 1 to 3, the circumferential wall of the housing body 11 is provided at intervals with a liquid inlet 16, a liquid outlet 17, and a cleaning inlet 18 that respectively communicate with the filter chamber 14. The liquid inlet 16 and the liquid outlet 17 are disposed opposite each other in a radial direction of the housing body 11. The cleaning inlet 18 is preferably located in the same plane as the liquid inlet 16 and the liquid outlet 17 along the axial direction, and is spaced 90° apart from the liquid inlet 16 and the liquid outlet 17. A through hole 121 is formed on the top cover 12, and a cleaning outlet 19 is formed on the bottom cover 13.

By way of example, as can be seen from FIG. 3, the liquid inlet 16 and the liquid outlet 17 may, as a separate part respectively, be fixed to the circumferential wall of the housing body 11. For instance, the circumferential wall of the housing body 11 is formed with two opposite openings in its radial direction, where one opening is used to connect a tubular liquid inlet 16, and the other opening is used to connect a tubular liquid outlet 17.

In some other embodiments, the tubular liquid inlet 16 and liquid outlet 17 may be integrally formed on the circumferential wall of the housing body 11, each communicating with the filter chamber 14.

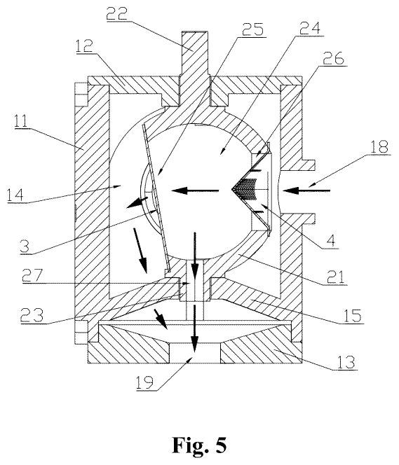

FIGS. 4 and 5 respectively show schematic views of the core 2 of the filter of the present embodiment in a filtering position and in a cleaning position. As shown in FIGS. 2, 4 and 5, according to the present embodiment, the core 2 is rotatably disposed in the filter chamber 14, and may include a core body 21, a core shaft 22, and a protrusion 23. The core body 21 is generally spherical and delimits an inner chamber 24. The core body 21 is provided with a first filtering port 25 and a second filtering port 26 on two opposite sides (e.g., the left and right sides as shown in FIGS. 4 and 5), each communicating with the inner chamber 24. By way of example, one side of the core body 21 has a beveled portion that is gradually inclined toward the center in a direction from top to bottom, and the first filtering port 25 is formed in this beveled portion. The side of the core body 21 opposite to the beveled portion is provided with a flat-cut portion extending in a vertical direction, and the second filtering port 26 is formed in this flat-cut portion.

The core shaft 22 extends upward from the top of the core body 21, and can pass into the through hole 121 in the top cover 12 when the core 2 is connected to the housing 1, such that the upper part of the core body 21 can be supported by the top cover 12. Moreover, the upper part of the core shaft 22 may also extend outside the top cover 12 for receiving a rotating handle, allowing the core 2 to be actuated to rotate in the filter chamber 14 by manipulating the rotating handle. The protrusion 23 extends downward from the bottom of the core body 21, and can pass into the annular portion of the bracket 15 when the core 2 is connected to the housing 1, such that the lower part of the core body 21 can be supported by the bracket 15. The extending direction of the core shaft 22 and the extending direction of the protrusion 23 may be on the same axis, thereby supporting the core 2 to rotate within the filter chamber 14 and switch between the filtering position and the cleaning position.

When the core 2 is in the filtering position, as shown in FIG. 4, the first filtering port 25 faces the liquid inlet 16, and the second filtering port 26 faces the liquid outlet 17. The fluid to be filtered flows in a filtering direction passing through the first filtering port 25 and the second filtering port 26 in sequence. When the core 2 is in the cleaning position, the spherical surface of the core body 21 seals the liquid inlet 16 and the liquid outlet 17, and the second filtering port 26 is aligned with the cleaning inlet 18 and preferably communicates with it through sealed connection. The cleaning fluid flows in a cleaning direction passing through the cleaning inlet 18, the second filtering port 26, the first filtering port 25, and the cleaning outlet 19 in sequence, as shown in FIG. 5. Although in FIG. 5 the connection between the second filtering port 26 and the cleaning inlet 18 is shown without seal, in practice, the second filtering port 26 and the cleaning inlet 18 can be sealed by a sealing ring or other conventional means, so as to prevent the cleaning fluid from flowing directly downward out of the cleaning outlet 19 from the gap between the second filtering port 26 and the cleaning inlet 18, thereby improving the cleaning efficiency. A core body through-hole 27 is provided at the bottom of the core body 21. It may, for example, extend downward from an inner wall of the core body 21 to the protrusion 23. In this way, the impurities retained in the inner chamber 24 after filtration can flow downward to the bottom cover 13 through the core body through-hole 27.

In the present disclosure, with the filtering device as the reference, the filtering direction and the cleaning direction are opposite. As shown in FIG. 4, the filtering direction is schematically from left to right, passing through the first filtering port 25 (where a first filtering screen 3 is disposed) and the second filtering port 26 (where a second filtering screen 4 is disposed) in sequence. Impurities in the fluid flowing in the filtering direction usually adhere to the side of the first filtering screen 3 away from the second filtering screen 4 (i.e., the left side in the figure) and the side of the second filtering screen 4 adjacent to the first filtering screen 3 (i.e., the left side in the figure). As shown in FIG. 5, the cleaning direction is from right to left, passing through the second filtering screen 4 and the first filtering screen 3 in sequence. This allows impurities on the left sides of the first filtering screen 3 and the second filtering screen 4 to be washed away by a relatively high pressure.

Referring to FIGS. 2, 4 and 5, the filtering device according to the present embodiment may include the aforementioned first filtering screen 3 and second filtering screen 4. The first filtering screen 3 is flat and made of a rigid material such as stainless steel. It is embedded in the first filtering port 25 and thus inclined toward the bottom of the core 2, facilitating impurities filtered by the first filtering screen 3 to fall to the bottom cover 13 under the action of gravity. The second filtering screen 4 is conical or arc-shaped, and recessed into the inner chamber 24. It is embedded in the second filtering port 26 to prevent interference between the second filtering screen 4 and the inner wall of the housing 1, and to allow impurities filtered by the second filtering screen 4 to fall to the bottom cover 13 under the action of gravity.

Of course, configurations of the first filtering screen 3 and the second filtering screen 4, such as their shapes and positions, are not limited to the specific examples listed herein. For example, the positions of the first filtering port 25 and the second filtering port 26 may be swapped. Moreover, when the first filtering screen 3 serves as primary filtration and the second filtering screen 4 serves as secondary filtration, the mesh count of the first filtering screen 3 may be slightly larger than that of the second filtering screen 4.

Referring to FIGS. 2 to 5, the filter according to the present embodiment may further include a first screw plug 5 and a second screw plug 6. The first screw plug 5 is arranged in the cleaning inlet 18, and the second screw plug 6 is arranged in the cleaning outlet 19, so that the cleaning inlet 18 and the cleaning outlet 19 can be sealed when the core 2 is in the filtering position. Preferably, the second screw plug 6 is configured as a magnetic screw plug, so that metal impurities falling to the bottom cover 13 under the action of gravity can be adsorbed on the second screw plug 6, and most of the impurities can be removed by detaching the second screw plug 6 before the filter is cleaned.

The filter of the present disclosure is particularly applicable to a cooling system of a work machine. In the cooling system, pressure sensors (not shown) may be respectively disposed at the liquid inlet 16 and the liquid outlet 17, so that whether the filter needs cleaning can be determined based on the pressure difference between the liquid inlet 16 and the liquid outlet 17. By way of example, the normal pressure difference for the fluid to be filtered to flow through the filter may be set according to the application environment of the cooling system, e.g. set as 1.5 standard atmospheres, and the maintenance condition or cleaning condition (i.e., the state where the filter needs cleaning) may be set to a pressure difference higher than the normal pressure difference during filtration, set as 3 to 5 standard atmospheres, for example.

It can be understood that the pressure difference between the liquid inlet 16 and the liquid outlet 17 of the filter may increase due to clogging of impurities on the first filtering screen 3 and the second filtering screen 4, and the cleaning condition depends on the requirements of the application environment. The higher the standard is set for the cleaning condition, the lower the cleaning frequency will be. During the cleaning process, the pressure of the cleaning fluid may be higher than that of the fluid in the filtering process, allowing impurities adhering to the first filtering screen 3 and the second filtering screen 4 to be washed away by the reverse flushing of the cleaning fluid.

### Industrial Applicability

The filter of the present disclosure is particularly suitable for cooling systems that dissipate heat and cool electric motors in work machines. However, it should be understood that the filter of the present disclosure can also be used in cooling systems of other motor vehicles that dissipate heat and cool electric drive devices, as well as other fluid systems that require fluid filtration.

The following describes the operation process of the filter of the present disclosure by taking the embodiment shown in FIGS. 1-5 as an example.

When the filter of the present disclosure is used for filtration, the core 2 may be rotated to the position shown in FIG. 4 by an operating device, such as the part of the core shaft 22 extending above the top cover 12 or an operating handle mounted on this part. This makes the first filtering screen 3 turn to and/or align with the liquid inlet 16, and the second filtering screen 4 turn to and/or align with the liquid outlet 17. At this time, the cleaning inlet 18 may be sealed by the first screw plug 5, and the cleaning outlet 19 may be sealed by the second screw plug. The peripheral edge of the second filtering port 26 may abut against the peripheral edge of the liquid outlet 17 to achieve sealing. In this way, after the fluid to be filtered enters the filter chamber 14 from the liquid inlet 16, most of the fluid passes through the first filtering screen 3 and the second filtering screen 4 for sequential layer-by-layer filtration, and then flows out from the liquid outlet 17. During the entire filtration process, since the inner chamber 24 of the core 2 is also connected to the liquid inlet 16 via the core body through-hole 27 and the channels between adjacent ribs of the bracket 15, the fluid in the core body through-hole 27—whether flowing from top to bottom or bottom to top—will eventually be filtered through the second filtering screen 4 and flow out from the liquid outlet 17.

When the pressure difference between the liquid inlet 16 and the liquid outlet 17 (measured by a pressure sensor, for example) reaches or exceeds a predetermined threshold, the core 2 is rotated to the position shown in FIG. 5 by means of the operating device, so that the outer spherical surface of the core body 21 can fit against and thus seal the liquid inlet 16 and the liquid outlet 17, and the second filtering port 26 and the cleaning inlet 18 can be aligned with each other and connected advantageously in a sealed manner. Then, the first screw plug 5 and the second screw plug 6 are removed, thereby establishing a flow path for the cleaning fluid that sequentially passes from the cleaning inlet 18 through the second filtering screen 4, the first filtering screen 3, and to the cleaning outlet 19. When the cleaning fluid enters into the filter chamber 14 at a certain pressure, a portion of the cleaning fluid may flow out through the core body through-hole 27 and the cleaning outlet 19, which are at its lower part, after backflushing the second filtering screen 4. Another portion of the cleaning fluid may continue to flow leftward to backflush the first filtering screen 3, and then flow out through the gaps between adjacent ribs of the bracket 15 and the cleaning outlet 19.

Compared with the prior art, the core 2 of the filter of the present disclosure can render the filtering device switching between the filtering position and the cleaning position. In the filtering position, the fluid to be filtered may pass through the filtering device in the forward direction along the filtering direction for filtration; in the cleaning position, the cleaning fluid may clean the filtering device in the reverse direction along the cleaning direction. This makes it unnecessary to drain the filtered fluid and disassemble the filter when the filter needs cleaning. Instead, the filer can be cleaned directly by adjusting the position of the core 2 while the filter remains connected to the fluid system. This is an on-line cleaning, with the entire cleaning and maintenance process to be simple and efficient.

In addition, the fluid to be filtered is subjected to two-stage layer-by-layer filtration by arranging the first filtering screen 3 and the second filtering screen 4 at the first filtering port 25 and the second filtering port 26 of the core 2 respectively. In this way, impurities with larger particle sizes can be filtered first, followed by impurities with smaller particle sizes. This improves the filtration efficiency and reduces the cleaning frequency.

For those skilled in the art, various modifications and variations of the embodiments disclosed herein may be made without departing from the scope or spirit of the present disclosure. Other embodiments of the present disclosure will be apparent to those skilled in the art according to the practice of the disclosure disclosed in this specification. The specification and examples disclosed herein shall be considered illustrative only, with the true scope of the present disclosure being determined by the appended claims and their equivalents.

1. A filter, comprising:
a housing, which defines a filter chamber and is provided with a liquid inlet, a liquid outlet, a cleaning inlet and a cleaning outlet respectively communicating with the filter chamber;
a core arranged within the filter chamber; and
a filtering device disposed on the core and being rotatable with the core between a filtering position and a cleaning position, wherein in the filtering position, the filtering device communicates with the liquid inlet and the liquid outlet so as to allow a fluid to be filtered to flow from the liquid inlet through the filtering device to the liquid outlet in a filtering direction; in the cleaning position, communication between the liquid inlet and the liquid outlet is cut off by the core, while the cleaning inlet and the cleaning outlet establish communication via the filtering device to allow a cleaning fluid to flow from the cleaning inlet through the filtering device to the cleaning outlet in a cleaning direction;
wherein with the filtering device as a reference, the filtering direction is opposite to the cleaning direction.

2. The filter according to claim 1, characterized in that a core body of the core defines an inner chamber and has a first filtering port and a second filtering port respectively communicating with the inner chamber, and the filtering device comprises a first filtering screen arranged within the first filtering port and a second filtering screen arranged within the second filtering port.

3. The filter according to claim 2, characterized in that the core body is generally spherical, the first filtering port and the second filtering port are opposite along a diameter of the core body, and can face the liquid inlet and the liquid outlet respectively when the core is in the filtering position.

4. The filter according to claim 3, characterized in that the first filtering port is formed in a beveled portion of the core body, and the first filtering screen (3) is planar and obliquely arranged within the first filtering port.

5. The filter according to claim 4, characterized in that the second filtering screen is in the shape of a cone or an arc recessed into the inner chamber.

6. The filter according to claim 5, characterized in that the core body has a core body through-hole at its bottom for allowing filtered impurities to fall through.

7. The filter according to claim 1, characterized in that the housing comprises a cylindrical housing body with openings on both ends, a top cover and a bottom cover mounted on the openings, wherein the liquid inlet the cleaning inlet and the liquid outlet are sequentially arranged in a circumferential wall of the housing body, and the cleaning outlet is arranged on the bottom cover.

8. The filter according to claim 7, characterized in that the filter further comprises a first screw plug and a second screw plug respectively disposed on the cleaning inlet and the cleaning outlet, wherein the second screw plug is a magnetic screw plug.

9. The filter according to claim 7, characterized in that the core comprises a core shaft extending from the top of the core body and a protrusion extending from the bottom of the core body, wherein the core shaft extends out through the top cover, and the protrusion is inserted into a bracket disposed at the bottom of the housing body.

10. A method for operating a filter, the filter comprising:
a housing, which defines a filter chamber and is provided with a liquid inlet, a liquid outlet, a cleaning inlet and a cleaning outlet respectively communicating with the filter chamber;
a core arranged within the filter chamber; and
a filtering device disposed on the core and being rotatable with the core, wherein the core can be disposed to enable the liquid inlet and the liquid outlet to communicate via the filtering device, so as to allow a fluid to be filtered to flow from the liquid inlet through the filtering device to the liquid outlet in a filtering direction;
the method comprising:
when cleaning conditions are met, rotating the core to cut off communication between the liquid inlet and the liquid outlet, and enabling the cleaning inlet and the cleaning outlet to form communication through the filtering device, thereby allowing the cleaning fluid to flow from the cleaning inlet through the filtering device to the cleaning outlet in a cleaning direction, wherein with the filtering device as a reference, the filtering direction is opposite to the cleaning direction.

11. The method according to claim 10, characterized in that the cleaning conditions include that a pressure difference between the liquid inlet and the liquid outlet reaches a predetermined threshold.
